(19) United States
(12) Patent Application Publication
(10) Pub. No.: US 2006/0018482 A1
(43) Pub. Date: Jan. 26, 2006

(54) Encryption processing method and device of a voice signal

(75) Inventor: Byung Sung Lee, KYUNGKI-DO (KR)

Correspondence Address: BRUCE E. LILLING;LILLING & LILLING P.C., P.O. BOX 560, GOLDEN BRIDGE, NY, 10526, US

(73) Assignee: ACEWAVETECH CO., LTD., INCHEON (KR)

(21) Appl. No.: 10/531,740

(22) PCT Filed: Oct. 16, 2003
(86) PCT No.: PCT/KR03/02154

§ 371 Date: Apr. 18, 2005

(30) Foreign Application Priority Data
Oct. 16, 2002 (KR) 10-2002-0063283
Oct. 15, 2003 (KR) 10-2003-0071692

(51) Int. Cl. H04K 1/00

(52) U.S. Cl. 380/275

(57) ABSTRACT

Disclosed is a method and system for encrypting an analog speech signal transmitted through a wired or wireless communication line. The system extracts magnitude data of each of the frequency components of the analog speech signal as a characteristic parameter at a specific time interval. The system rearranges obtained characteristic parameters spatially and time-serially, converts the resultant data into an analog signal and transmits the signal through a communication line. The characteristic parameters are extracted through a predetermined algorithm whose inverse transform is easily carried out, for example, FFT, DCT and WAVELET transform, or various subband division techniques using band pass filters.

### TECHNICAL FIELD

The present invention relates to a method and system for encrypting analog speech signals transmitted through a wired/wireless communication line.

### BACKGROUND ART

In case of transmission of an audible sound such as a speech signal, in general, the audible sound is converted into an electric analog signal using a sound input device, a microphone, for instance, first. Then, the electric analog signal is encoded through PCM (Pulse Code Modulation) or ADPCM (Adaptive Differential PCM), for example, and transmitted by a communication method such as TDM (or TDMA) or CDMA.

However, this conventional speech signal transmission/reception system has a problem that an ill-intended third person can easily eavesdrop a speech signal transmitted through a communication line. In case of PSTN (Public Switched Telephone Network) currently widely being used, for example, a telephone that is a user terminal is connected to an exchange of a telephone office through a telephone line, and the telephone converts an audible sound inputted thereto into an electric analog signal to transmit it to the exchange. Then, the exchange encodes the received analog signal through PCM or ADPCM and sends the encoded signal to another exchange through a trunk. In this communication network, accordingly, an ill-intentioned third person can easily eavesdrop the speech signal transmitted through the telephone line only by connecting a predetermined communication terminal to the telephone line that connects the user's telephone with the exchange. This illegal eavesdropping is not limited to the above-described communication network but it can be easily carried out for all communication networks including wireless and wired communication methods.

Accordingly, important public institutions and facilities employ an encryption system for encrypting analog signals transmitted from user terminals to cope with the illegal eavesdropping.

FIG. 1 is a block diagram of a conventional analog signal encryption system. In FIG. 1, reference numeral 1 denotes an input part of a microphone that converts an audible sound into an analog signal, and 2 represents an encryption unit for encrypting the analog speech signal inputted through the input part 1. This encrypting unit 2 consists of an analog/digital converter 21 for converting the analog signal into digital data, an encrypting processor 22 for encrypting the digital data outputted from the analog/digital converter 21, and a digital/analog converter 23 for converting the digital data outputted from the encryption processor 22 into an analog signal.

The encrypting processor 22 rearranges the digital data outputted from the analog/digital converter 21, that is, speech data, spatially and time-serially or executes frequency conversion for speech data of a specific time interval, to thereby encrypt the speech data. Here, spatial rearrangement means that a predetermined digital value is added to or subtracted from digital data of a predetermined section so as to change the intensity of the corresponding analog signal. The time-serial rearrangement means that the digital data is exchanged with digital data of another section or inversely arranged.

FIG. 2 shows an example of encryption processed by the encryption unit 2. FIG. 2a illustrates the waveform of the analog signal inputted through the input part 1 and FIG. 2b shows the waveform of the analog signal outputted from the digital/analog converter 23 of the encryption unit 2. In FIGS. 2a and 2b, the horizontal axes represent time and vertical axes indicate signal intensities. Referring to FIGS. 2a and 2b, a data value corresponding to “2” is added to the input signal so that the input signal is spatially rearranged with respect to the data of section a-b. Data of section b-c and data of section c-d are exchanged with each other and the signal of section d-e is inversely arranged such that the data of section b-e is rearranged time-serially. In addition, the conventional encryption unit 2 carries out frequency conversion for a speech signal of a predetermined time interval, which is not shown in the figure. That is, in the conventional encryption system and method, an input speech signal is rearranged spatially and time-serially and a speech signal of a predetermined section is frequency-converted so that a third person cannot recognize the speech signal.

However, the conventional encryption system has the following problems.

1. A third person can recognize that a corresponding speech signal has been encrypted even if he/she cannot eavesdrop the speech signal because the conventional encryption system rearranges the speech signal only spatially and time-serially or frequency-converts it. Accordingly, an ill-intentioned third person may record the signal to try to analyze it.

2. Every person has his/her own characteristic speech signal, in general, and the speech signal has continuity. Thus, an encrypted speech signal can be decoded when it is accurately analyzed on the basis of these characteristics.

FIG. 3 shows waveform characteristic of a speech signal with respect to time and FIG. 4 shows spectrum characteristic of the speech signal of FIG. 3 with respect to time. These graph the speech signal using Cool-Edit 2000 program. As shown in FIGS. 3 and 4, every person has his/her own characteristic speech signal having continuity. Accordingly, an encrypted speech signal that has been rearranged spatially and time-serially or frequency-converted can be easily restored to the original speech signal when the encrypted speech signal is decoded on the basis of the characteristics.

### DISCLOSURE OF INVENTION

An object of the present invention is to provide an encryption method and system for securely encrypting an analog signal transmitted through a communication line.

To accomplish the object of the present invention, there is provided a method for encrypting a speech signal transmitted through a communication line, comprising a characteristic parameter extracting step of splitting the speech signal into predetermined frequency components and extracting a magnitude value of each of the frequency components; and a data transmission step of transmitting the parameter data extracted at the characteristic parameter extracting step through the communication line.

The encryption method further comprises a rearrangement step of rearranging a series of characteristic parameters obtained at the characteristic parameter extracting step.

To accomplish the object of the present invention, there is also provided a system for encrypting a speech signal transmitted through a communication line, comprising an analog/digital conversion means for converting an analog speech signal into digital data; a characteristic parameter extracting means for extracting a magnitude value of each of frequency components of the data; and a digital/analog conversion means for converting the data obtained by the characteristic parameter extracting means into an analog signal.

The encryption system further comprises a rearrangement means for rearranging a series of characteristic parameters outputted from the characteristic parameter extracting means.

### BRIEF DESCRIPTION OF THE DRAWINGS

Further objects and advantages of the invention can be more fully understood from the following detailed description taken in conjunction with the accompanying drawings, in which:

FIG. 1 is a block diagram of a conventional analog signal encryption system;

FIG. 2a shows the waveform of the analog signal inputted through the input part 1 of the system of FIG. 1;

FIG. 2b shows the waveform of the analog signal outputted from the digital/analog converter 23 of the encryption unit 2 of FIG. 1;

FIG. 3 shows waveform characteristic of a speech signal with respect to time;

FIG. 4 shows spectrum characteristic of the speech signal of FIG. 3 with respect to time;

FIG. 5 is a block diagram of a speech signal encryption system according to an embodiment of the present invention;

FIGS. 6 and 7 are waveform diagrams for explaining waveform characteristic of the encryption system of FIG. 5;

FIG. 8 is a block diagram of an encryption system according to another embodiment of the present invention; and

FIG. 9 is a block diagram of a decoding system for restoring a signal transmitted through the encryption system of FIG. 8 to the original signal.

### BEST MODE FOR CARRYING OUT THE INVENTION

The present invention will now be described in detail in connection with preferred embodiments with reference to the accompanying drawings.

First of all, the basic concept of the present invention will be described below.

An analog signal can be represented by a plurality of sine and cosine functions having different number of vibrations, that is, frequencies, or by a composite function of sine and cosine. In other words, an analog signal can be divided into a plurality of frequency components having different magnitudes.

For instance, a periodic function f(t) can be developed as series of multiple sine functions as follows.

$$f ( t ) = \frac{{a}_{0}}{2} + {a}_{1} cos ω t + {a}_{2} cos 2 ω t + … + {a}_{n} cos n ω t + {b}_{1} sin ω t + {b}_{2} sin 2 ω t + … + {b}_{n} sin n ω t$$

That is, the periodic function can be divided into multiple frequency components having different magnitudes.

The original analog signal can be obtained by combining the multiple frequency components having different magnitudes, represented by the aforementioned equation.

Accordingly, if there is a predetermined agreement between transmitting and receiving systems, the transmitting system can transmit the analog signal represented by the periodic function f(t) only by delivering

$$\frac{{a}_{0}}{2} , {a}_{1} , {a}_{2} , … , {a}_{n} , {b}_{1} , {b}_{2} , … , {b}_{n}$$

that are magnitudes of the frequency components in the equation.

This concept can be applied even to transmission and reception of general speech signals in the same manner. Specifically, when a speech signal having frequency band of 0-4 KHz is split into thirty-two frequency components, for example, frequency components that respectively have 0, 125 Hz, 250 Hz, . . . , 4 KHz are obtained. These frequency components can be combined to restore the original speech signal. Accordingly, if speech signal transmitting and receiving systems agree on a method of splitting and combining the speech signal, the transmitting system transmits only the magnitudes of the frequency components to the receiving system for the purpose of perfect transmission and reception of the speech signal.

The present invention splits an input speech signal into predetermined frequency components, extracts a magnitude value of each of the frequency components, that is, characteristic parameter, converts the extracted characteristic parameter into an analog signal and transmits the analog signal through a communication line.

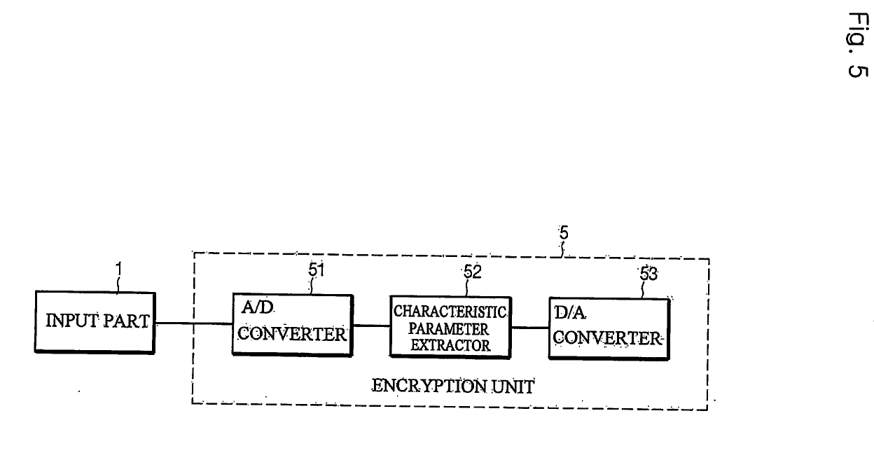

FIG. 5 is a block diagram of a speech signal encryption system according to an embodiment of the present invention. Referring to FIG. 5, the encryption system 5 of the present invention includes an analog/digital converter 51 for converting an analog speech signal inputted through an input part 1 into digital data, a characteristic parameter extractor 52 for extracting a characteristic parameter, that is, magnitude data of each frequency component, from the digital data, and a digital/analog converter 53 for converting parameter data outputted from the characteristic parameter extractor 52 into analog data.

The characteristic parameter extractor 52 is composed of a digital signal processor or a microprocessor, for example, which executes a predetermined algorithm in which inverse transform is easily performed, for instance, FFT (Fast Fourier Transform), DCT (Discrete Cosine Transform) and WAVELET transform or various subband dividing techniques using band pass filters, to extract characteristic parameters from input data.

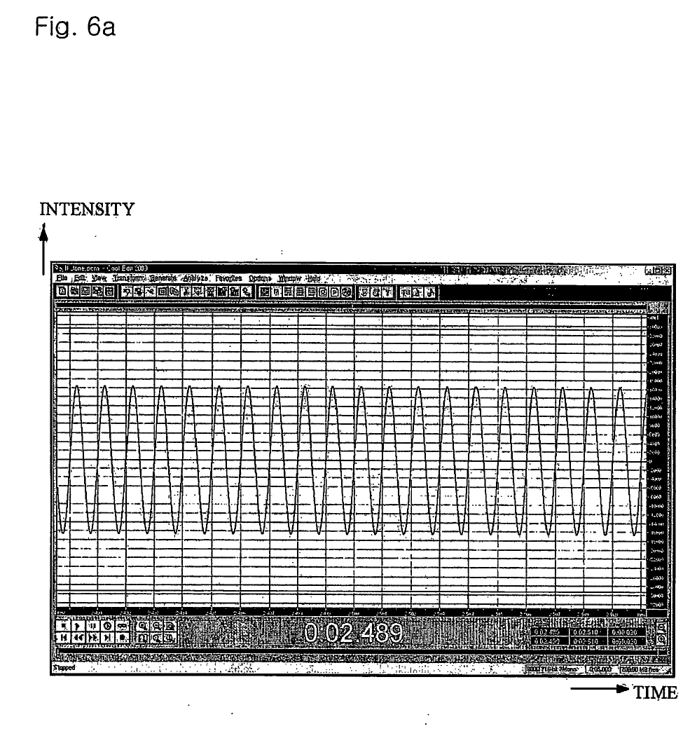

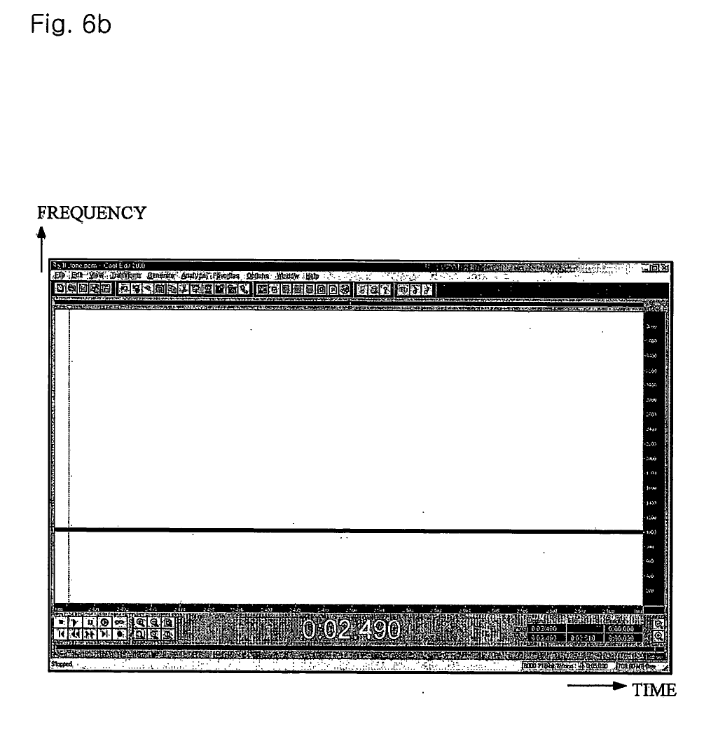

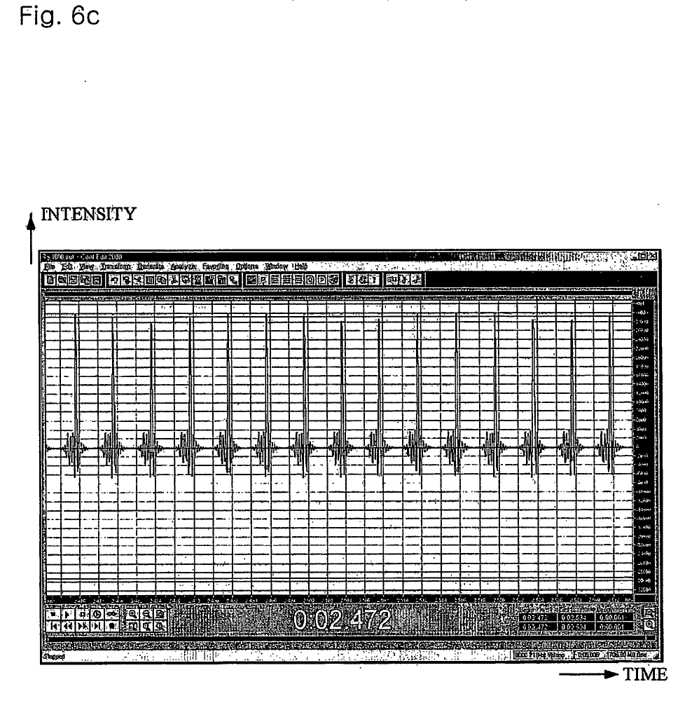

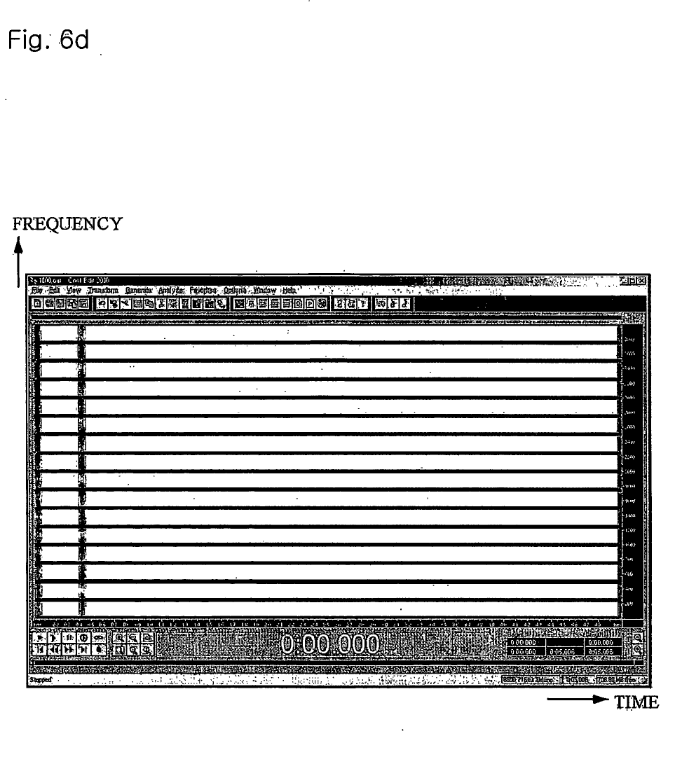

FIG. 6 shows characteristic waveforms obtained when a sine wave having the frequency of 1 KHz is inputted to the encryption system of the present invention. These waveforms were acquired by using Cool Edit 2000 program. FIG. 6a shows 1 KHz sine wave inputted to the encryption system of the present invention, and FIG. 6b illustrates spectrum characteristic of the sine wave according to time. In addition, FIG. 6c shows a variation in the magnitude of the signal outputted from the digital/analog converter 53 of the encryption system 5 with respect to time when the 1 KHz sine wave is inputted to the encryption system of the present invention. FIG. 6d shows spectrum characteristic of the signal of FIG. 6c according to time.

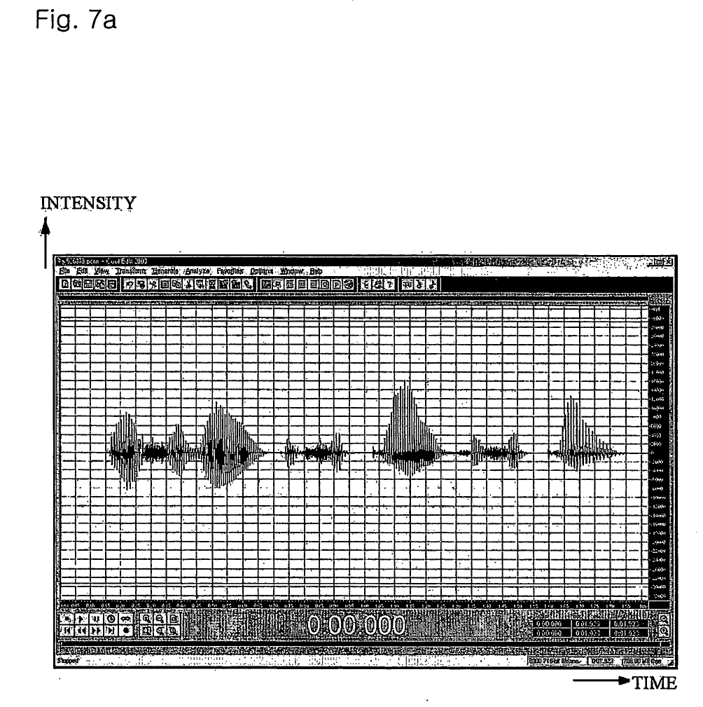

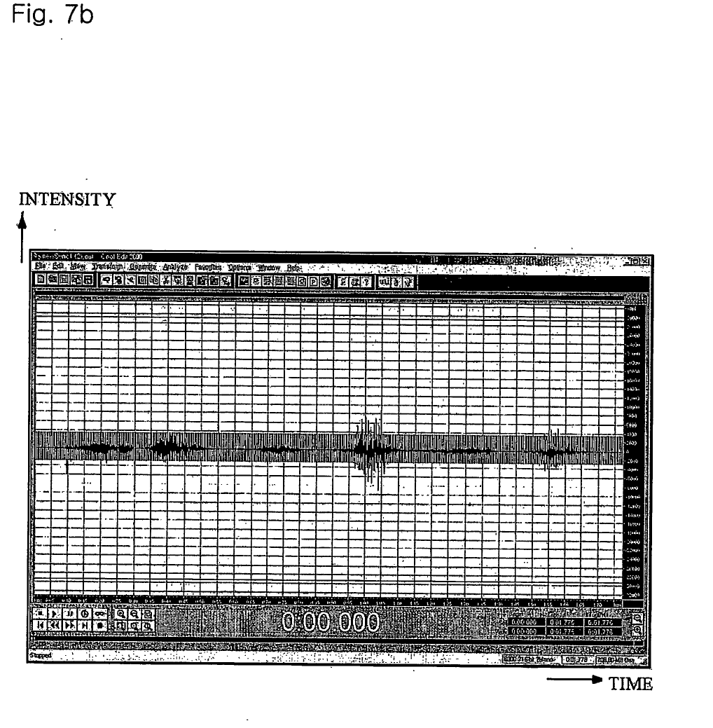

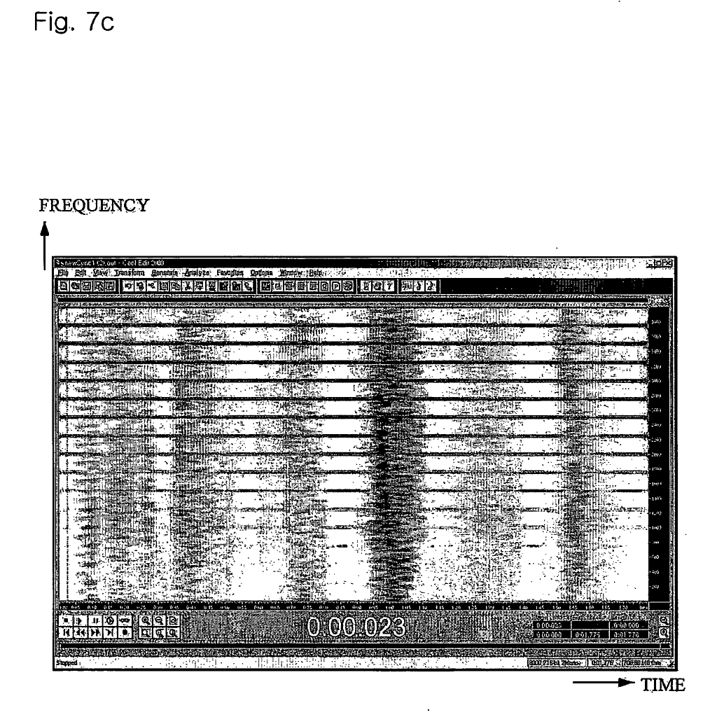

FIG. 7 shows characteristic waveforms obtained when an actual speech signal is inputted to the encryption system of the present invention. FIG. 7a illustrates a variation in the speech signal with respect to time, and FIG. 7b is a waveform diagram showing a variation in the signal outputted from the digital/analog converter 53 of the encryption system 5 with respect to time when the speech signal is inputted to the encryption system. FIG. 7c illustrates spectrum characteristic of the signal outputted from the digital/analog converter 53 with respect to time.

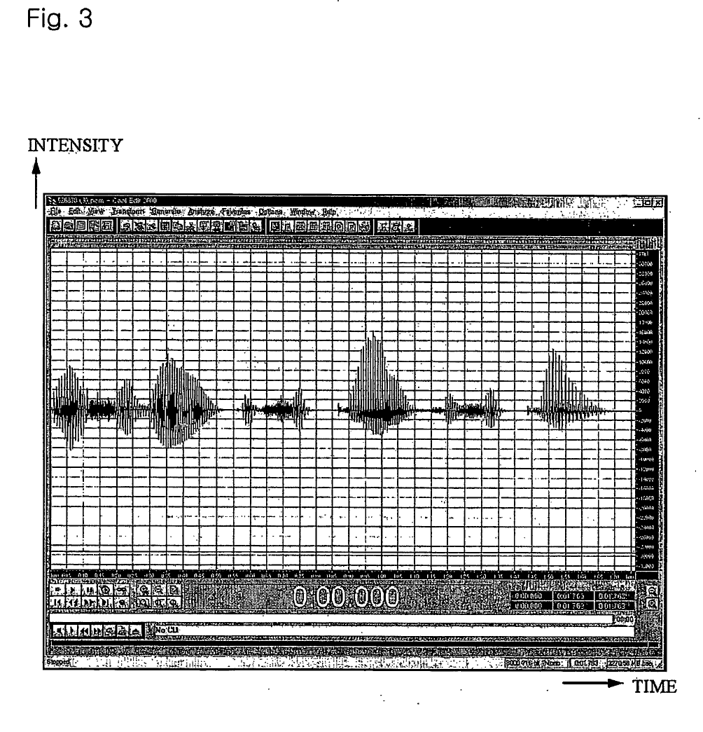

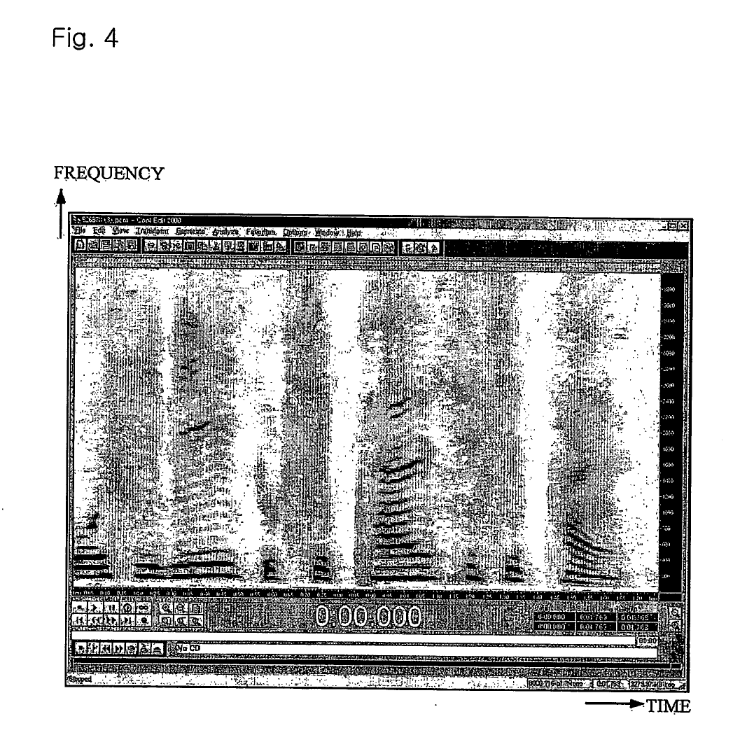

Upon comparison of the waveforms shown in FIGS. 3 and 4 according to the conventional system with the waveforms of FIGS. 6 and 7 obtained by the present invention, the encryption system of the present invention newly generates an analog signal based on the magnitude of each of frequency components of the input analog signal. This completely destroys regularity and continuity of the original speech signal. Accordingly, in the case that a speech signal is encrypted and transmitted through the encryption system of the present invention, an ill-intentioned third person cannot confirm whether the transmitted signal is a speech signal or simple noise even if he/she eavesdrops the transmitted signal. Furthermore, even if the third person judges that the signal is a speech signal, he/she cannot recognize the transmitted signal because the signal does not have the regularity and continuity of the original speech signal.

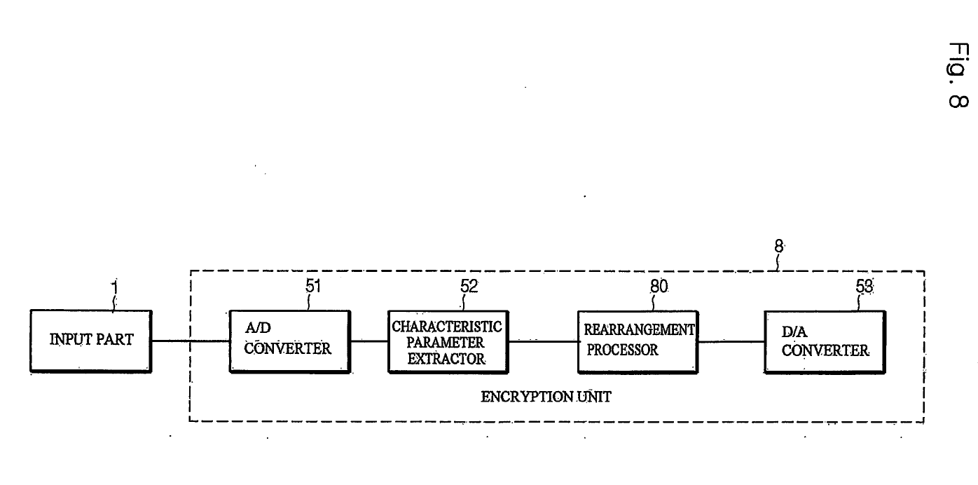

FIG. 8 is a block diagram of an encryption system according to another embodiment of the present invention. This encryption system has higher degree of encryption than the encryption system of FIG. 5. Like reference numerals designate corresponding parts throughout FIGS. 5 and 8.

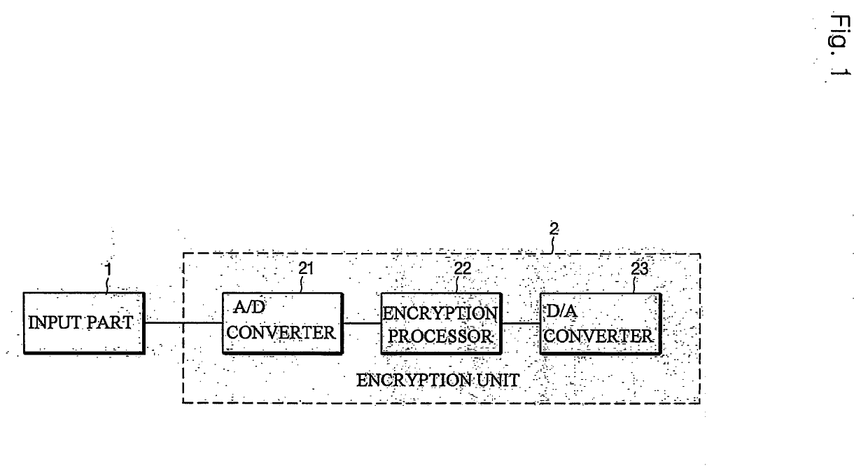

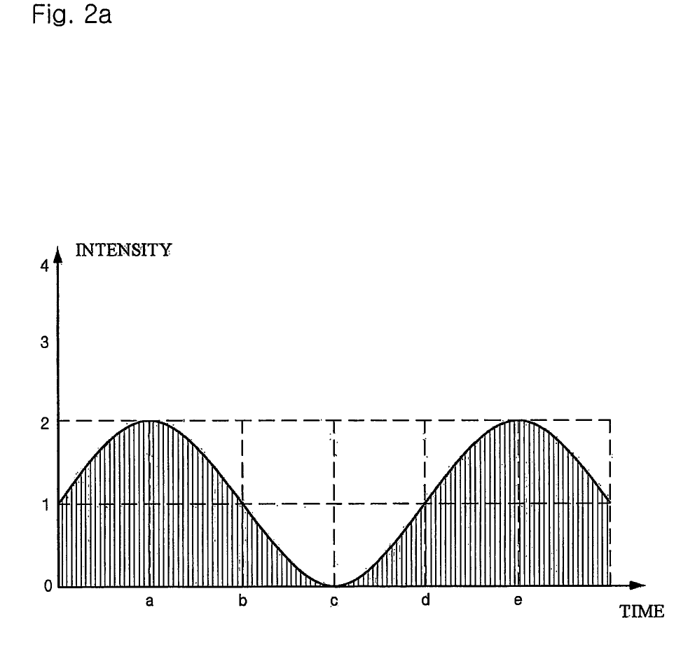

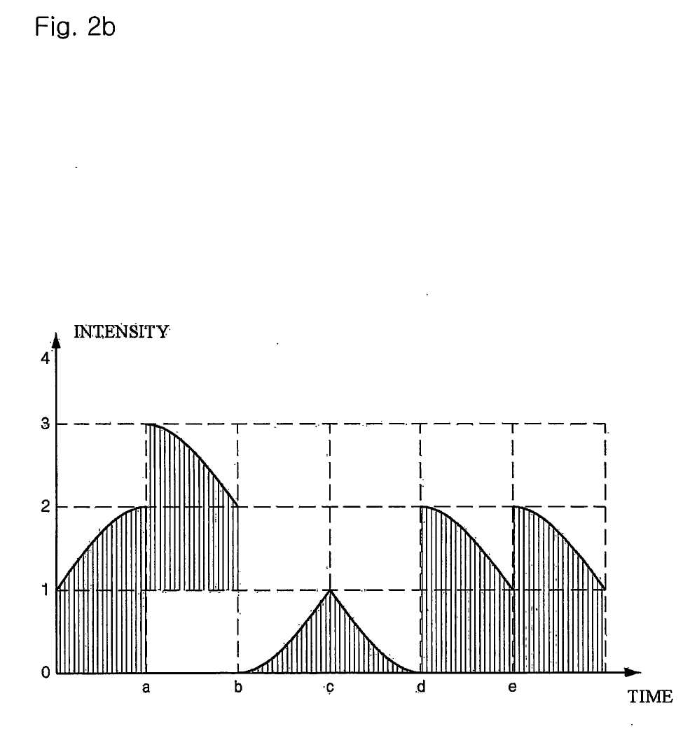

As shown in FIG. 8, the encryption system according to another embodiment of the invention additionally includes a rearrangement processor 80 for rearranging the digital data outputted from the characteristic parameter extractor 52 spatially or time-serially. The rearrangement processor 80 corresponds to the encryption processor 22 of the conventional encryption system, shown in FIG. 1, and subtracts/adds a predetermined data value from/to input data or changes the position of the data.

In the conventional encryption system of FIG. 1, the data inputted to the encryption processor 22 is magnitude data of the speech signal with respect to time. Thus, the original signal can be easily restored on the basis of continuity of the speech signal even if the input data is rearranged through the encryption processor 22 spatially and time-serially. In the encryption system shown in FIG. 8, however, the data extracted from the characteristic parameter extractor 52 corresponds the magnitude of each of the frequency components of the speech signal so that the data is changed into a signal completely different from the original signal when the magnitude value of the data is changed or rearranged time-serially. In the above-described embodiment, especially, magnitude data of each of the frequency components of the speech signal is set as transmission data so that regularity and continuity of the original signal are completely destroyed. Accordingly, an ill-intentioned third person cannot restore the rearranged data to the original data. As a result, the present invention can securely prevent the third person from eavesdropping the speech signal transmitted through the communication line.

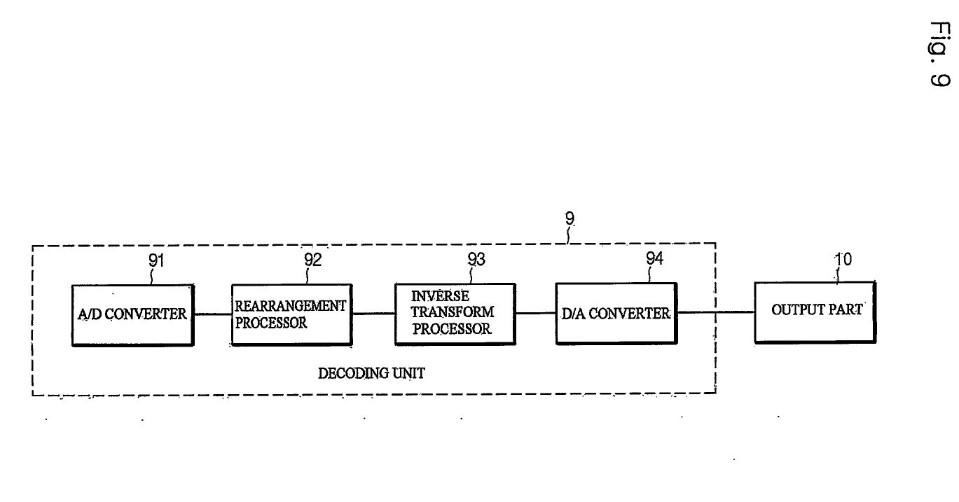

FIG. 9 is a block diagram of a decoding system for restoring the signal transmitted through the encryption system to the original signal, which corresponds to the encryption system 8 shown in FIG. 8.

In FIG. 9, reference numeral 9 denotes a decoding unit for restoring the signal encrypted by the encryption unit 8 to the original signal, and 10 represents an output part for outputting the analog signal outputted from the decoding unit 9 as an audible sound, for example, a speaker.

The decoding unit 9 consists of an analog/digital converter 91 for converting an input analog signal into digital data, a rearrangement processor 92, an inverse transform processor 93, and a digital/analog converter 94 for converting digital data outputted from the inverse transform processor into an analog signal. Here, the rearrangement processor 92 inversely carries out the rearrangement performed by the rearrangement processor 80 of the encryption system of FIG. 8, to generate the same data as the data outputted from the characteristic parameter extractor 52. The inverse transform processor 93 inversely transforms the transform processing performed by the characteristic parameter extractor 52, that is, FFT, DCT and WAVELET transform, or combines the original frequency signals with magnitude data of various subbands, to restore the input signal data to the original speech data.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

As described above, the present invention can securely encrypt analog speech signals transmitted through communication lines.

What is claimed is:

1. A method for encrypting a speech signal transmitted through a communication line, comprising:
a characteristic parameter extracting step of splitting the speech signal into predetermined frequency components and extracting a magnitude value of each of the frequency components; and
a data transmission step of transmitting the parameter data extracted at the characteristic parameter extracting step through the communication line.

2. A method for encrypting a speech signal transmitted through a communication line, comprising:
an analog/digital conversion step of converting an analog speech signal into digital data;
a characteristic parameter extracting step of extracting a magnitude value of each of frequency components of the data; and
a digital/analog conversion step of converting the data extracted at the characteristic parameter extracting step into an analog signal.

3. The method for encrypting a speech signal as claimed in claim 2, wherein the characteristic parameter extracting step includes an FFT processing step.

4. The method for encrypting a speech signal as claimed in claim 2, wherein the characteristic parameter extracting step includes DCT processing step.

5. The method for encrypting a speech signal as claimed in claim 2, wherein the characteristic parameter extracting step includes WAVELET transform processing step.

6. The method for encrypting a speech signal as claimed in claim 2, wherein the characteristic parameter extracting step includes a subband dividing step.

7. The method for encrypting a speech signal as claimed in claim 2, further comprising a rearrangement step of rearranging a series of characteristic parameters obtained at the characteristic parameter extracting step.

8. The method for encrypting a speech signal as claimed in claim 7, wherein rearrangement of the characteristic parameters change magnitude values of the characteristic parameters.

9. The method for encrypting a speech signal as claimed in claim 7, wherein the rearrangement step rearranges the characteristic parameters time-serially.

10. A system for encrypting a speech signal transmitted through a communication line, comprising:
an analog/digital conversion means for converting an analog speech signal into digital data;
a characteristic parameter extracting means for extracting a magnitude value of each of frequency components of the data; and
a digital/analog conversion means for converting the data obtained by the characteristic parameter extracting means into an analog signal.

11. The system for encrypting a speech signal as claimed in claim 10, wherein the characteristic parameter extracting means extracts characteristic parameters through FFT.

12. The system for encrypting a speech signal as claimed in claim 10, wherein the characteristic parameter extracting means extracts characteristic parameters through DCT.

13. The system for encrypting a speech signal as claimed in claim 10, wherein the characteristic parameter extracting means extracts characteristic parameters through WAVELET transform.

14. The system for encrypting a speech signal as claimed in claim 10, wherein the characteristic parameter extracting means extracts characteristic parameters through subband division.

15. The system for encrypting a speech signal as claimed in claim 10, further comprising a rearrangement means for rearranging a series of characteristic parameters outputted from the characteristic parameter extracting means.

16. The system for encrypting a speech signal as claimed in claim 15, wherein the rearrangement means changes magnitude values of the characteristic parameters.

17. The system for encrypting a speech signal as claimed in claim 15, wherein the rearrangement means rearranges the characteristic parameters time-serially.
